(19) United States
(12) Patent Application Publication
(10) Pub. No.: US 2010/0130069 A1
(43) Pub. Date: May 27, 2010

(54) Low Crosstalk Twisted Pair Communications Connectors Including Meta-Material Structures

(76) Inventor: James R. Fyne, Blue Ridge, TX (US)

Correspondence Address: MYERS BIGEL SIBLEY & SAJOVEC, P.O. BOX 37428, RALEIGH, NC, 27612, US

(21) Appl. No.: 12/276,704

(22) Filed: Nov. 24, 2008

(51) Int. Cl. H01R 24/00

(52) U.S. Cl. 439/676

(57) ABSTRACT

Communications connectors include a plurality of conductors that form a plurality of pairs of conductors. Each pair of conductor is configured to carry a differential signal. The communications connectors further include at least one meta-material structure positioned adjacent at least some of the conductors. This meta-material may act to reduce pair-to-pair and/or alien crosstalk.

### FIELD OF THE INVENTION

The present invention relates generally to communications connectors and, more particularly, to communications connectors that are used to connect cables that include a plurality of twisted pairs of conductors.

### BACKGROUND

Many hardwired communications systems use communications plug and jack connectors to connect a communications cable to another communications cable or to a piece of equipment such as a computer, printer, server, switch or patch panel. By way of example, high speed communications systems routinely use such plug and jack connectors to connect computers, printers and other devices to local area networks and/or to external networks such as the Internet.

In hardwired communications systems, it is often advantageous to transmit information signals (e.g., video, audio, data) over a pair of conductors (a “differential pair”) using “balanced” transmission techniques, rather than over a single conductor. The conductors may comprise, for example, wires, contacts, printed circuit board traces, conductive vias and/or combinations thereof. The signals transmitted on each conductor of the differential pair have equal magnitudes, but opposite phases, and the information signal is embedded as the voltage difference between the signals carried on the two conductors.

When a signal is transmitted over a conductor, electrical noise from external sources such as lightning, electronic equipment, automobile spark plugs, radio stations, etc. may be picked up by the conductor, degrading the quality of the signal carried by the conductor. With balanced transmission techniques, each conductor in a differential pair often picks up approximately the same amount of noise from these external noise sources. Because approximately the same amount of noise is added to the signals carried by both conductors of the differential pair, the noise generally does not degrade the information signal, as the information signal is extracted by taking the difference of the signals carried on the two conductors of the differential pair, and thus the noise signal may be substantially cancelled out by the subtraction process.

Many communications systems interconnect two end devices using multiple differential pairs. For example, the typical telephone line includes two differential pairs (i.e., a total of four conductors). Similarly, the above-mentioned high speed communications systems typically include four differential pairs. The set of differential pairs (e.g., four differential pairs) that are used to connect two end devices are referred to as a “communications channel.”

FIG. 1 is a simplified example of a communications system that illustrates how plug and jack connectors may be used to interconnect a computer 10 to, for example, a network server 20. As shown in FIG. 1, the computer 10 is connected by a cable 12 to a jack 15 that is mounted in a wall plate. The cable 12 is a patch cord that includes a plug 13, 14 at each end thereof. The cable 12 includes eight wire conductors that are arranged as four differential pairs so that the cable can simultaneously carry four differential signals, and each plug 13, 14 likewise includes eight contacts, namely one for each of the eight conductors in the cable 12. Plug 13 inserts into a jack (not pictured in FIG. 1) that is provided in the back of the computer 1. Plug 14 inserts into an opening or “plug aperture” 16 in the front side of the jack 15 so that the contacts of the plug 14 mate with eight corresponding contacts of the jack 15. The jack 15 includes a wire connection assembly 17 that includes eight wire connection terminals at the back end thereof Each of the conductors of a second cable 18 is mated with a respective one of the wire connection terminals of the wire connection assembly 17. The jack 15 include eight conductive paths, where each path connects one of the jack contacts to a respective one of the wire connection terminals. Thus, the jack 15 establishes electrical connections between each conductor of the second cable 18 and a respective one of the contacts of the plug 14. The other end of the second cable 18 is connected to a network server 20 which may be located, for example, in a telecommunications closet of a commercial office building. Thus, the patch cord 12, the cable 18 and the jack 15 provide four differential signal paths between the computer 10 and the network server 20. It will be appreciated that typically one or more patch panels or switches, along with additional communications cabling, would be included in the electrical path between the second communications cable 18 and the network server 20. However, for ease of description, these additional elements have been omitted from FIG. 1 and the second communications cable 18 is instead shown as being directly connected to the network server 20.

In a communications system such as the system of FIG. 1, the four differential pairs of conductors in the plugs, jacks and cables are typically in very close proximity. As a result, capacitive and inductive coupling will typically occur between the conductors of the four differential pairs. These capacitive and inductive couplings give rise to another type of noise that is called “crosstalk.”

“Crosstalk” in a differential communication system refers to an unwanted signal that appears on both conductors of a “victim” differential pair that is induced by a disturbing differential pair. “Crosstalk” includes both near-end crosstalk, or “NEXT”, which is the crosstalk measured at an input location corresponding to a source at the same location (i.e., crosstalk whose induced voltage signal travels in an opposite direction to that of an originating, disturbing signal in a different path), as well as far-end crosstalk, or “FEXT”, which is the crosstalk measured at the output location corresponding to a source at the input location (i.e., crosstalk whose signal travels in the same direction as the disturbing signal in the different path). Both NEXT and FEXT are undesirable signals that interfere with the information signal.

A variety of techniques may be used to reduce crosstalk in differential communications systems such as, for example, tightly twisting the paired conductors (which are typically insulated copper wires) in a cable. The differential pairs are typically twisted at different rates that are not harmonically related so that each conductor in the cable picks up approximately equal amounts of signal energy from the two conductors of each of the other differential pairs in the cable. This twisting of the conductors and various other known techniques may substantially reduce crosstalk in cables. Unfortunately, however, the jack and plug configurations that were adopted years ago generally did not maintain the conductors of each differential pair a uniform distance from the conductors of the other differential pairs in the connector hardware. Moreover, in order to maintain backward compatibility with connector hardware that is already in place in existing homes and office buildings, the connector configurations have, for the most part, not been changed. As such, the conductors of each differential pair tend to induce unequal amounts of crosstalk on each of the other differential pairs in current plug and jack connectors. As a result, many current connector designs generally introduce some amount of NEXT and FEXT crosstalk between differential pairs that are part of the same communications channel. Herein, such crosstalk is referred to as “pair-to-pair” crosstalk.

FIG. 2 depicts the conductor configuration specified for RJ-45 style jacks, as set forth in, for example, the TIA/EIA-568-B.2-1 industry standard document that was approved on Jun. 20, 2002 by the Telecommunications Industry Association. RJ-45 style jacks and plugs are the types of connectors that are most typically used to connect computers and other electronic devices to local area networks and/or to Internet connections. As shown in FIG. 2, an RJ-45 style jack includes eight conductors 1-8 that comprise four differential pairs. The industry standards specify that in the connection region where the contacts of an RJ-45 plug mate with the contacts of the jack (i.e., the plug-jack mating point), the eight conductors 1-8 are aligned in a row, with the four differential pairs specified as depicted in FIG. 2. As is apparent from FIG. 2, in this connection region, the conductors of each differential pair are not equidistant from the conductors of the other differential pairs. By way of example, conductor 2 (pair 2) is closer to conductor 3 (pair 3) than is conductor 1 (pair 2) to conductor 3. Consequently, differential capacitive and/or inductive coupling occurs between the conductors of pairs 2 and 3 that generate both NEXT and FEXT. Similar differential coupling occurs with respect to the other differential pairs in the plug and jack.

Another type of crosstalk that is often present in hardwired communications systems is “alien” crosstalk. Alien crosstalk is the differential crosstalk that occurs between the differential pairs in a first communications channel (i.e., the four differential pairs in a series of cables, jacks and plugs that connect first and second end devices) and the differential pairs in a second communications channel (i.e., the four differential pairs in a series of cables, jacks and plugs that connect third and fourth end devices). In particular, in communications systems that use RJ-45 plugs and jacks, pair-to-pair unbalances in the plug-jack combination coupled with mode conversion can result in, for example, the conductors of pair 3 of one channel crosstalking to the conductors of pair 3 of another channel.

U.S. Pat. No. 5,997,358 to Adriaenssens et al. (hereinafter “the '358 patent”) describes one method for reducing crosstalk in communications connectors using multi-stage crosstalk compensation schemes. The plug-jack connectors described in the '358 patent can reduce the “offending” crosstalk that may be induced from the conductors of a first differential pair onto the conductors of a second differential pair by deliberately generating “compensating” crosstalk signals that reduce or substantially cancel the offending crosstalk. As discussed in the '358 patent, two or more stages of compensating crosstalk may be provided, where the magnitude and phase of the compensating crosstalk signal induced by each stage, when combined with the compensating crosstalk signals from the other stages, provide a composite compensating crosstalk signal that substantially cancels the offending crosstalk signal over a frequency range of interest. The multi-stage (i.e., two or more) compensation schemes disclosed in the '358 patent can be more efficient at reducing crosstalk than schemes in which the compensation is added at a single stage, especially when the second and subsequent stages of compensation include a time delay that is selected and/or controlled to account for differences in phase between the offending and compensating crosstalk signals.

Another common method of reducing crosstalk is to provide grounded shielding between each differential pair in the plug and jack connectors and/or in the communications cabling. Communications systems that use such shielding are typically referred to as shielded twisted pair or foiled twisted pair systems. This approach, however, can significantly increase the cost of both the cables and connectors, requires a connection to earth ground, and can also increase both the weight and size of the communications cables. Due to these disadvantages, such shielded twisted-pair communications systems are far less prevalent than unshielded twisted pair (UTP) communications systems. Another approach that may be used to reduce at least alien crosstalk is to provide spatial separation between the cables, plugs and jacks of different channels. However, this is typically impractical because bundling of cables and patch cords is common practice due to “real estate” constraints and ease of wire management.

### SUMMARY

Embodiments of the present invention provide communications connectors that include a plurality of conductors that form a plurality of pairs of conductors. In these connectors, each pair of conductor may be configured to carry a differential signal. The connectors further include at least one meta-material structure that is positioned adjacent at least some of the conductors. The meta-material structure may be configured to reduce pair-to-pair and/or alien crosstalk.

In some embodiments, the connectors may comprise a communications jack, and each conductor may be a jackwire contact. In other embodiments, the communications connector may be a communications plug, and each conductor may be a plug contact. A variety of different meta-material structures may be used, including, for example, a split ring resonator, an array of split ring resonators or one or more reverse transmission lines. In some embodiments, the meta-material structure may be formed by printing metallic ink on a substrate.

In some embodiments, the connector includes at least two meta-material structures, namely a first meta-material structure that is positioned above the conductors and a second meta-material structure that is positioned below the conductors. In other embodiments, the meta-material structure is positioned between a first of the pairs of conductors and a second of the pairs of conductors.

Pursuant to further embodiments of the present invention, communications connectors are provided that have a housing, a plurality of contacts mounted at least partly within the housing, and a meta-material structure mounted to or within the housing. In these connectors, the meta-material structure is positioned so as to reduce electromagnetic fields that emanate from one or more of the plurality of contacts.

In some embodiments, the communications connector may be a communications plug having contacts that are arranged in a generally side-by-side relationship to form a row of contacts. In these embodiments, the meta-material structure may, for example, be positioned either above or below the row of contacts. In other embodiments, the communications connector may be a communications jack and the housing may define a generally rectangular plug receiving cavity having a top wall, a bottom wall and first and second side walls. In these embodiments, meta-material structures may, for example, be positioned adjacent to the top wall, the bottom wall, the first side wall and/or the second side wall of the plug receiving cavity.

Pursuant to further embodiments of the present invention, methods of reducing crosstalk in a communications connector are provided. The communications connector includes a plurality of differential pairs of conductors. In these methods, at least one meta-material structure is positioned adjacent at least some of the plurality of differential pairs of conductors. In this manner, it may be possible to reduce pair-to-pair and/or alien crosstalk generated by the conductors of the connector.

### BRIEF DESCRIPTION OF THE FIGURES

FIG. 1 is a simplified schematic diagram illustrating the use of conventional communications plugs and jacks to interconnect a computer with network equipment.

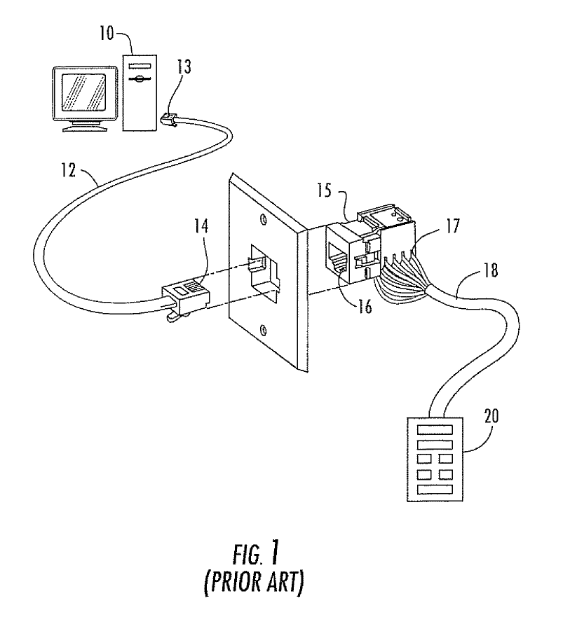

FIG. 2 shows the modular jack contact wiring assignments for an 8-position communications Jack (T568B) as viewed from the front opening of the jack.

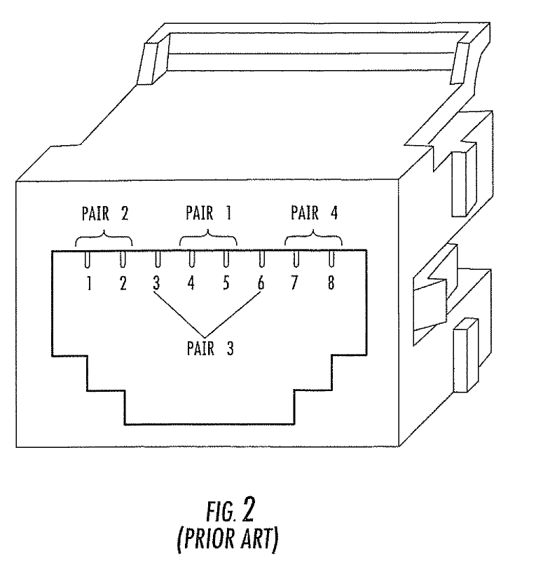

FIG. 3 is a plan view of a split ring resonator that may be used as a meta-material structure in communications connectors according to certain embodiments of the present invention.

FIG. 4A is a schematic perspective diagram of a model in which a split ring resonator is positioned between a pair of monopole antennas.

FIG. 4B is a graph illustrating the ability of a split ring resonator to act as a meta-material.

FIG. 5A is a plan view of an array of split ring resonators that may be used as a meta-material structure in connectors according to embodiments of the present invention.

FIG. 5B is a perspective view of a plurality of the arrays of split ring resonators of FIG. 5A.

FIG. 6 is a perspective view of a patch panel in which jacks according to embodiments of the present invention may be used.

FIG. 7 is an exploded perspective view of a jack according to certain embodiments of the present invention.

FIG. 8 is a partially exploded perspective view of a jack according to farther embodiments of the present invention.

FIG. 9 is a cross-sectional view of a plug according to embodiments of the present invention.

FIG. 10 is an exploded perspective view of a plug according to further embodiments of the present invention.

FIG. 11 is a circuit diagram of a reverse transmission line that may be used as a meta-material structure in communications connectors according to certain embodiments of the present invention.

FIG. 12 is a perspective of another split ring resonator that may be used as a meta-material structure in communications connectors according to embodiments of the present invention.

### DETAILED DESCRIPTION

The present invention is described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between”, “adjacent” versus “directly adjacent”, etc.).

Relative terms such as “below” or “above” or “upper” or “lower” or “horizontal” or “vertical” may be used herein to describe a relationship of one element to another element as illustrated in the figures. It will be understood that these terms are intended to encompass different orientations of the device in addition to the orientation depicted in the figures.

In the claims appended hereto, as well as in the summary section above, it will be understood that the terms “first”, “second”, “third” and the like, when used in reference to a contact, conductor, differential pair or other element, are not used to refer to a specific contact wire, conductor or differential pair or other element as specified in a specific standardized connector configuration (e.g., the TIA/EIA 568, type B configuration), but instead are used merely to distinguish one contact wire, conductor or differential pair or other element from other contact wires, conductors or differential pairs, etc. that are recited in the claim. Thus, for example, a “first differential pair” of a connector that is referenced in the claims may refer to any differential pair in the connector, and thus is not limited to, for example, pair 1 of the TIA/EIA 568, type B configuration.

The present invention is directed to communications connectors that may exhibit reduced crosstalk levels. The primary examples of such connectors are communications jacks, plugs and connecting blocks that include a plurality of differential pairs of metallic conductors such as, for example, RJ-45 jacks and plugs, 110-style plugs and 110-style connecting blocks. As is described in detail herein, the communications connectors according to embodiments of the present invention include one or more “meta-material structures” that are used to reduce the electromagnetic radiation emitted from the conductors of the connector. As a result, the communications connectors according to embodiments of the present invention may exhibit low levels of pair-to-pair and/or alien crosstalk.

As is known in the art, the response of a material to an electromagnetic wave is determined by the dielectric permittivity and the magnetic permeability of the material. Certain artificial structures exist—which are commonly referred to as “meta-materials” or as “left-handed materials”—that exhibit a negative effective permittivity and a negative effective permeability over some range of frequencies. In such materials, the index of refraction is less than zero over the frequency range having negative effective permittivity and permeability, and therefore the direction of propagation of the electromagnetic wave is reversed (i.e., backward wave propagation). As a result, meta-materials can be used to make electromagnetic radiation focus in on itself. Herein, the term “meta-material structure” is used to refer to a structure that includes one or more meta-materials that has an index of refraction which is less than zero over some range of frequencies. As noted above, pursuant to embodiments of the present invention, communications connectors are provided that include meta-material structures that are used to reduce crosstalk between pairs of conductors within the connector and/or between the conductors of the connector and the conductors of an adjacent connector.

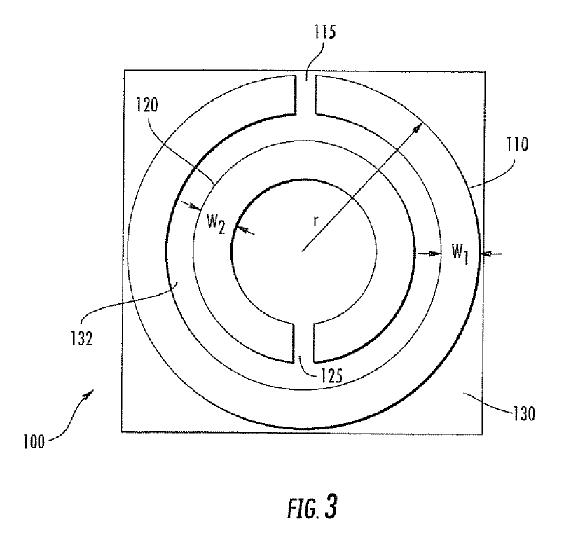

Pursuant to certain embodiments of the present invention, communications connectors are provided that include one or more split ring resonators. Split ring resonators are one known type of meta-material structure. FIG. 3 depicts a split ring resonator 100 that may be used in communications connectors according to embodiments of the present invention. As shown in FIG. 3, the split ring resonator 100 comprises a first ring 110 and a second ring 120 that may be disposed on a substrate 130 (note that in some embodiments the substrate 130 may be omitted). The first ring 110 is larger than the second ring 120, and the second ring 120 is disposed within the first ring 110 so that the first and second rings 110, 120 form a pair of concentric rings. The first ring 110 includes a small gap 115, and the second ring 120 includes a small gap 125. As shown in FIG. 3, typically, the gap 115 is on a first side of the first ring 110 and the gap 125 is on the opposite side of the second ring 120.

As shown in FIG. 3, each ring 110, 120 may have a respective width w₁, w₂, and the outside diameter of the first ring 110 may define a radius (r) of the split ring resonator 100. The gaps 115, 125 and the gap 132 between the inner and outer rings 110, 120 induce the magnetic resonance that allows the split ring resonator to exhibit a negative index of refraction over some range of frequencies. By adjusting the size of the gaps 115, 125 and the spacing 132 between the first and second rings (relative to the dimensions of the rings themselves), it is possible to tune the range of frequencies for which the split ring resonator 100 exhibits a negative index of refraction.

The substrate 130 may be any substrate that is capable of supporting the first and second rings 110, 120. In some embodiments, the substrate 130 may comprise a printed circuit board, and the rings 110, 120 may be implemented as conductive traces that are printed on or within the printed circuit board. In other embodiments, the substrate 130 may comprise a substantially thinner material, such as paper or a thin plastic material. In such embodiments, the rings 110, 120 may comprise, for example, a metallic ink such as carbon ink that is printed on the paper or other substrate.

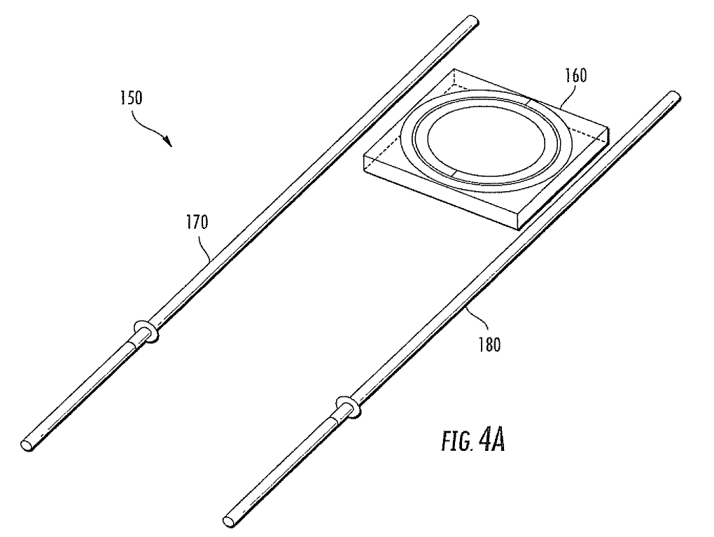

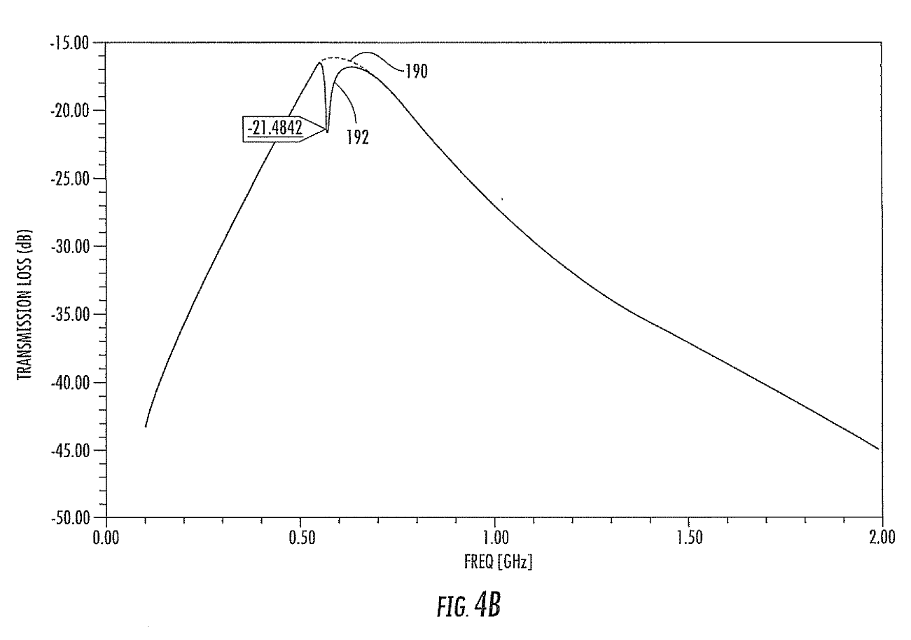

FIG. 4A is a schematic perspective diagram of a model 150 in which a split ring resonator model 160 is positioned between a pair of monopole antennas 170, 180. FIG. 4B is a two dimensional plot that includes two graphs thereon. The first graph, labeled 190 and shown with a dotted line, illustrates, as a function of frequency, the approximate magnitude of the signal received at monopole antenna 180 when monopole antenna 170 emits a signal and no split ring resonator is interposed between the two antennas 170, 180. As shown in graph 190, the antenna is tuned to emit signals at a frequency of about 600 MHz, and the received signal strength drops off significantly at frequencies on both sides of 600 MHz. The second graph 192 (shown by the solid line) illustrates, as a function of frequency, the modeled magnitude of the signal received at monopole antenna 180 in response to the signal emitted by monopole antenna 170 when the split ring resonator 160 is interposed between the two antennas as shown in FIG. 4A. As shown in graph 192 of FIG. 4B, the signal received at antenna 180 is reduced by approximately 5 dB at 573 MHz. This null at 573 MHz results from the backward wave propagation effects generated by the split ring resonator 160, and illustrates how a split ring resonator may be used to reduce emissions from an electromagnetic radiation source. Note that graphs 190 and 192 overlap except in the region between about 520 MHz and about 640 MHz.

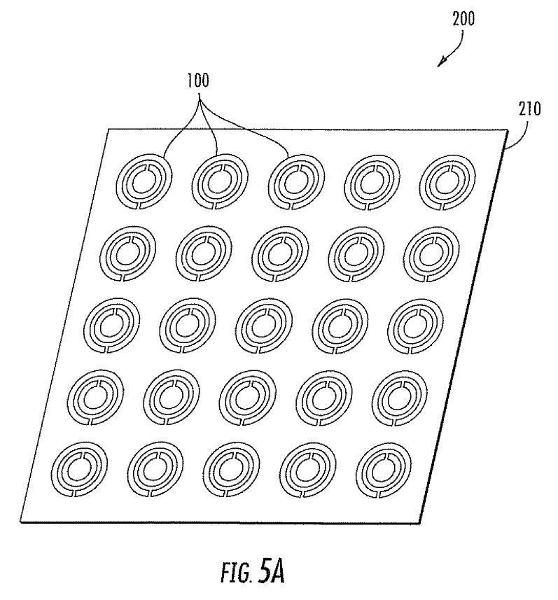

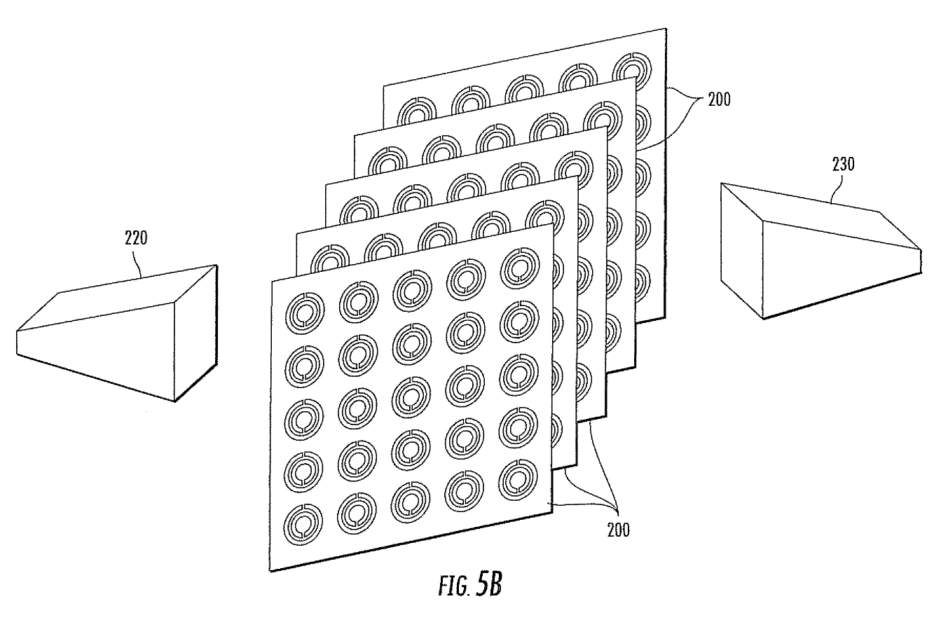

As will be discussed in greater detail herein, in some embodiments of the present invention, a single meta-material structure such as, for example, the split ring resonator 100 illustrated in FIG. 3 may be used to reduce the crosstalk in a specified direction. In other embodiments, the meta-material structure may comprise an array of meta-materials (e.g., an array of split ring resonators). FIG. 5A illustrates one such array 200 of split ring resonators. As shown in FIG. 5A, a 5×5 array of split ring resonators 100 may be disposed on a substrate 210. It will be appreciated that the number of meta-materials included in the array may be varied, and that the array need not be symmetrical. Moreover, in some embodiments, a plurality of arrays such as the array 200 may be used to provide increased crosstalk reduction. FIG. 5B illustrates how a plurality of the arrays 200 may be interposed between an electromagnetic radiation source 220 such as, for example, a conductor of a differential pair in a communications connector and a conductive structure 230 that receives energy from the electromagnetic radiation source 220. The use of multiple arrays can provide enhanced reduction of the amount of electromagnetic energy received at structure 230 from electromagnetic radiation source 220.

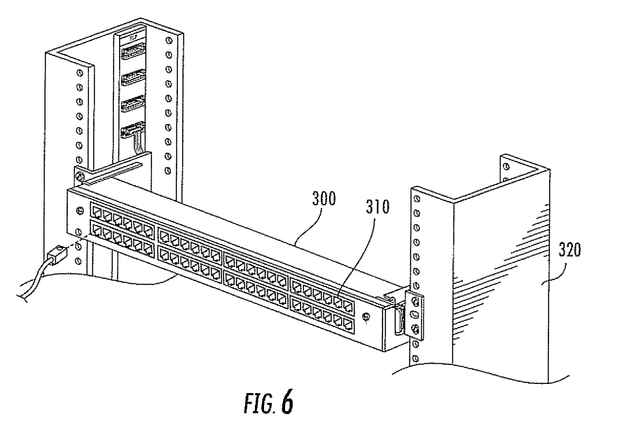

Pursuant to certain embodiments of the present invention, communications jacks may be provided that include meta-material structures that may be designed to reduce alien crosstalk. These communications jacks may be used, for example, in patch panels or in other applications in which multiple communications jacks may be mounted in close proximity to each other. By way of illustration, FIG. 6 depicts a typical structure of an RJ-45 style patch panel 300 that may be used, for example, to connect backbone cabling to network equipment. As shown in FIG. 6, the patch panel 300 include forty-eight RJ-45 jacks 310 that are arranged in two horizontal rows of twenty-four jacks each. As is also shown in FIG. 6, the patch panel 300 may be mounted on an equipment rack 320. Typically, a plurality of patch panels such as the patch panel 300 will be mounted on rack 320, with each patch panel 300 being mounted directly above the patch panel 300 below it. As a result, most of the jacks 310 in the patch panels that are mounted on each equipment rack 320 will have a jack 300 directly above it, directly below it, and on each side of it. Thus, to the extent that the conductors of a particular jack 310 emit a differential crosstalk signal in the direction of any of the adjacent jacks 310, then alien crosstalk issues may arise.

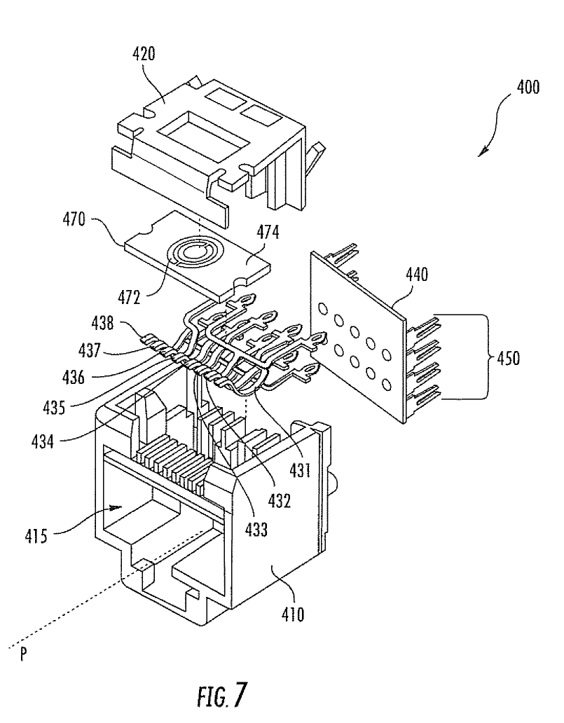

In order to reduce alien crosstalk that can arise when a jack is used in an application where it is closely adjacent to other jacks, such as in the patch panel 300 discussed above with reference to FIG. 6, jacks according to the present invention are provided that include meta-material structures that reduce alien crosstalk. FIG. 7 illustrates one such communications jack 400.

As shown in FIG. 7, the communications jack 400 includes a jack frame 410, a cover 420, a plurality of contacts that are in the form of spring contact wires 431-438, a printed circuit board 440, a plurality of insulation displacement contacts that are broadly designated as 450, and a meta-material structure 470. An IDC cover (not shown in FIG. 7) would also typically be provided.

The jack frame 410 includes a plug aperture 415 which comprises a cavity that is sized and configured to receive a mating communications plug that is inserted into the plug aperture 415 along the plug axis “P” shown in FIG. 7. The cover 420 extends across the top of the jack frame 410. The jack frame 410, the cover 420 and the IDC cover (not shown) together comprise a housing that defines the plug aperture and protects other of the components of the communications jack 400. The jack frame 410, the cover 420 and the IDC cover (not shown) may be made of a suitable insulative plastic material that meets all applicable standards with respect to, for example, electrical breakdown resistance and flammability such as, for example, polycarbonate, ABS, and blends thereof. Those skilled in this art will recognize that a wide variety of other configurations of housings may also be employed in embodiments of the present invention, and that the housing may comprise more or less pieces than the exemplary housing illustrated in FIG. 7.

The contact wires 431-438 each comprise a conductive element that is used to make physical and electrical contact with a respective contact on a mating communications plug. Typically, the contact wires 431-438 comprise spring contact wires that are formed of resilient metals such as spring-tempered phosphor bronze, beryllium copper, or the like. A typical cross section of each contact wire 431-438 is 0.017 inches wide by 0.010 inches thick. As shown in FIG. 7, the contact wires 431-438 may include, for example, “eye-of-the-needle” termination that may be press-fit into respective metal-plated apertures on the wiring board 440 in cantilever fashion so as to extend into the plug aperture 415.

The contact wires 431-438 are arranged in differential pairs as defined by TIA 568B. In particular, contact wires 434, 435 form a first differential pair (pair 1) of contact wires that may be used to carry a first differential signal, contact wires 431, 432 form a second differential pair (pair 2) of contact wires that may be used to carry a second differential signal, contact wires 433, 436 form a third differential pair (pair 3) of contact wires that may be used to carry a third differential signal, and contact wires 437, 438 form a fourth differential pair (pair 4) of contact wires that may be used to carry a fourth differential signal. Thus, jack 400 may carry up to four differential signals at a time. As shown in FIG. 7, contact wires 434, 435 are in the center positions in the contact wire array, contact wires 431, 432 are adjacent to each other and occupy the rightmost two positions (from the vantage point of FIG. 7) in the sequence, and contact wires 437, 438 are adjacent to each other and occupy the leftmost two positions (from the vantage point of FIG. 7) in the sequence. Contact wires 433, 436 are positioned so that, in the plug contact regions of the contact wires, these contact wires sandwich contact wires 434, 435 (i.e., contact wires 434 and 435 are both positioned between contact wires 433 and 436 in the plug contact region of the contact wires).

Each of the contact wires 431-438 has a deflectable (moveable) portion that extends into the plug aperture 415 and a fixed portion that is mounted in the wiring board 440. The deflectable portion of each contact wire 431-438 includes a plug contact region, which is the portion of the contact wire that is configured to make physical contact with a respective one of the contacts (e.g., plug blades) on a mating plug when the mating plug is received within the plug aperture 415 of communications jack 400 along the direction of the horizontal plug axis P. As shown in FIG. 7, the plug contact regions of all eight contact wires may be aligned in a generally parallel, side-by-side relationship. As is also shown in FIG. 7, the deflectable portion of some of the contact wires 431-438 may further include a crossover section where the contact wire crosses over and/or under one or more of the other contact wires when the contact wires 20 are viewed from above for purposes of crosstalk compensation.

The printed circuit board 440 may be formed of conventional materials, and may be a single layer board or may have multiple layers. The printed circuit board 440 may be substantially planar as illustrated, or may be non-planar. Each of the contact wires 431-438 is mounted in cantilever fashion to the printed circuit board 440. A plurality of conductive paths (not visible in FIG. 7) are provided on the printed circuit board 440. The conductive paths (which may comprise, for example, one or more conductive traces and/or conductive vias) may be formed of conventional conductive materials and may be deposited on the printed circuit board 440 via any deposition method known to those skilled in this art to be suitable for the application of conductors. A respective one of the conductive paths connects each of the contact wires 431-438 to a respective one of the output terminals 450.

The eight output terminals 450 project rearwardly from the printed circuit board 440 to connect electrically with respective conductors (e.g., the conductors of a twisted pair cable). In this particular embodiment, the output terminals 450 are in the form of eight insulation displacement contacts (“IDCs”) 450. An IDC 450 is inserted into a respective one of eight metal plated IDC apertures that are provided on the printed circuit board 440. The IDCs may be of conventional construction and need not be described in detail herein; exemplary IDCs are illustrated and described in U.S. Pat. No. 5,975,919 to Arnett.

Finally, the connector 400 includes a meta-material structure 470 that is mounted on top of the contact wires 431-438 and beneath the cover 420. In this particular embodiment, the meta-material structure comprises a single split ring resonator 472 that is printed on a printed circuit board 474. The meta-material structure 470 may be designed to decrease the electromagnetic fields emitted by the contacts 431-438 and the contacts of the mating plug that is inserted into the plug aperture 415 at least in the upward direction. In this manner, the meta-material structure 470 may act to reduce the alien crosstalk that jack 400 (and the mating plug inserted therein) transmits in the upward direction where it might be received by conductors of jacks located, for example, directly above jack 400 (or above and to one side of jack 410). It will be appreciated in light of the present disclosure that the above-described meta-material structure 470 may reduce pair-to-pair crosstalk in addition to alien crosstalk. In particular, by reversing the direction of the electromagnetic fields of the contacts 431-438, the meta-material structure 470 may act to generally reduce the extent of the electromagnetic field emitted by each of the contacts 431-438, which may also have the effect of reducing the net amount of pair-to-pair crosstalk in the connector 400.

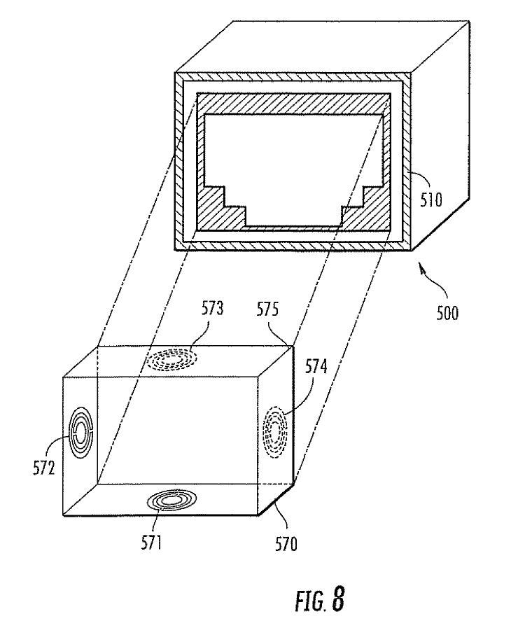

FIG. 8 is a perspective view of a jack frame 510 and a meta-material structure 570 of a jack 500 according to further embodiments of the present invention. The jack 500 may be similar or identical to the jack 400 of FIG. 7 except that the meta-material structure 470 of jack 400 is replaced in jack 500 with a four-sided meta-material structure 570, and the jack frame 410 and cover 420 of jack 400 are replaced with the jack frame 510. The meta-material structure 570 may reduce the alien crosstalk that jack 500 (and the mating plug inserted therein) transmits in the upward, downward and both sideward directions, and may also reduce pair-to-pair crosstalk. The four-sided meta-material structure 570 may comprise, for example, a paper substrate 575 onto which four split ring resonators 571-574 are printed in carbon ink. The substrate 575 is then folded into the shape shown in FIG. 8. The housing 510 of jack 500 is modified somewhat from the housing 410, 420 of jack 400 so that the housing 510 includes a compartment that receives the four-sided meta-material structure 570.

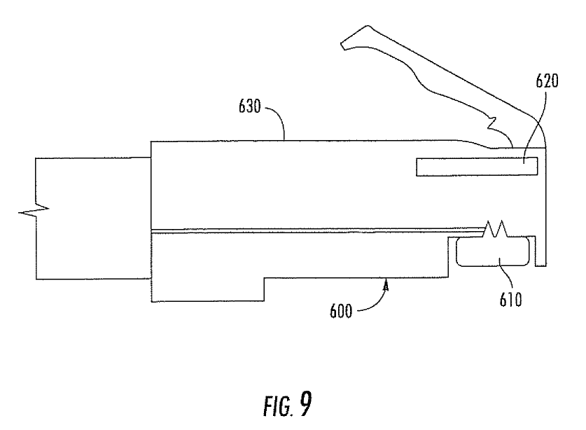

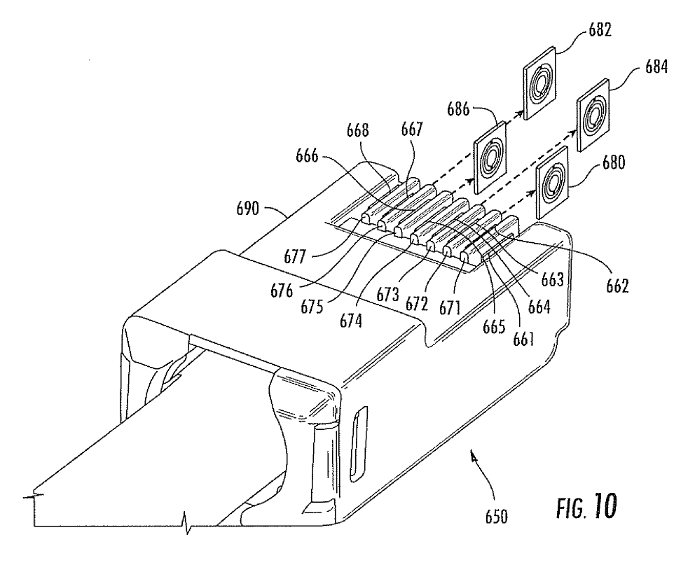

FIG. 9 is a cross-sectional view of a plug 600 according to further embodiments of the present invention. As shown in FIG. 9, the plug 600 may comprise any conventional RJ-45 plug. The plug includes a plurality of plug blades 610 (one of which is visible in the cross-sectional view of FIG. 9). The plug blades 610 are aligned in a row in a well-known industry standardized configuration (see FIG. 10). As is further shown in FIG. 9, a substrate 620 is mounted in a housing 630 of plug 600. This substrate 620 includes at least one meta-material structure such as, for example, a split ring resonator such as the split ring resonator 100 of FIG. 3 or an array of split ring resonators such the array 200 depicted in FIG. 5A. The substrate 620 including the meta-material structure may be used to reduce alien crosstalk and/or pair-to-pair crosstalk.

FIG. 10 is an exploded perspective view of a plug 650 according to further embodiments of the present invention. As shown in FIG. 10, the plug 650 includes a plurality of plug blades 661-668 which are aligned in a row in a well-known industry standardized configuration. Each plug blade 661-668 is positioned within a respective one of a plurality of slots that are defined by a plurality of blade walls 671-677 and the housing 690. Each slot exposes a portion of the top surface and the front surface of the plug blade so that the plug blade may make a mechanical and electrical connection with a corresponding contact of a jack into which the plug 650 is inserted. As is further shown in FIG. 10, four substrates 680, 682, 684, 686 are positioned within the housing 690 of plug 650. In particular, substrate 680 is positioned in a vertical orientation within or on blade wall 672. Substrate 682 is likewise positioned in a vertical orientation within or on blade wall 676. Substrate 684 is positioned in a vertical orientation within or on blade wall 673. Finally, substrate 686 is positioned in a vertical orientation within or on blade wall 675. Each substrate 680, 682, 684, 686 includes one or more meta-material structures that may be used to reduce pair-to-pair crosstalk between the plug blades 661-668.

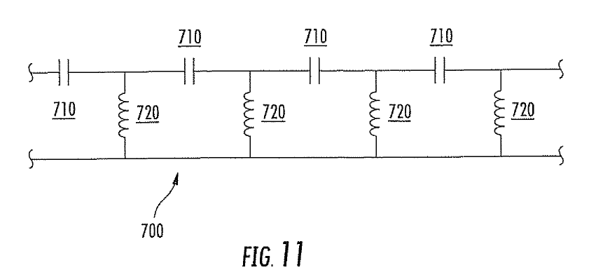

FIG. 11 is a circuit diagram of a reverse transmission line that may be used as a meta-material structure in communications connectors according to certain embodiments of the present invention. As is known to those of skill in the art, an ideal (lossless) transmission line may be modeled as a plurality of inductors coupled in series with a capacitor that is connected to a return path provided after each inductor. As shown in FIG. 11, a reverse transmission line 700 may be implemented as a plurality of capacitors 710 that are coupled in series, with an inductor 720 that is connected to a return path provided after each capacitor 710. According to further embodiments of the present invention, the connectors described above may use reverse transmission lines such as reverse transmission line 700 as meta-material structures instead of, or in addition to, split ring resonators or other meta-material structures.

It will also be appreciated that any other meta-material structure may be used in the connectors according to embodiments of the present invention. By way of example, split ring resonators that have more than one gap may act as meta-materials. For example, in some embodiments, each ring of the split ring resonators may have two gaps that are separated by 180 degrees, where one ring is rotated 90 degrees with respect to the other ring. In other embodiments, each ring may include four gaps, and the gaps on the two rings may be aligned. In still other embodiments, single ring resonators may be used, where the ring has, for example, one, two or four gaps. It will be appreciated that the rings on the split ring resonators need not be circular. For example, a generally square “ring” could alternatively be used.

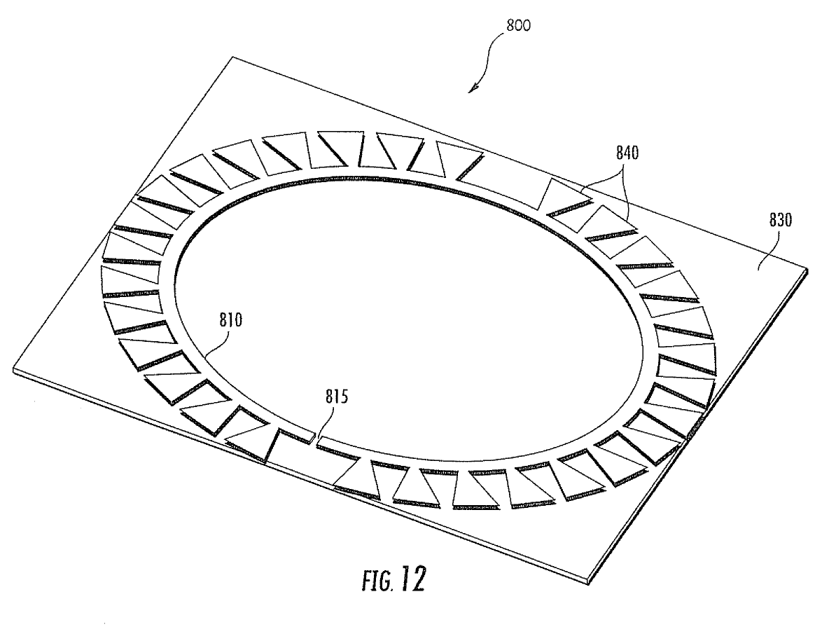

FIG. 12 illustrates another example of a split ring resonator 800 that may be used as a meta-material structure in connectors according to embodiments of the present invention. As shown in FIG. 12, the split ring resonator 800 comprises a first ring 810 that is disposed on the first side of a substrate 830. An identical ring 820 (not visible in FIG. 12) is disposed on the reverse side of substrate 830 in exact alignment with ring 820. Ring 810 includes a gap 815. Ring 820 likewise includes a gap 825, that is offset 180 degrees from the gap 815. Each ring 810, 820 further includes a plurality of triangular protrusions 840. As the triangular protrusions of the first ring 810 exactly overlap the triangular protrusions 840 of the second ring 820, these triangular protrusions act as plate capacitors thereby increasing the capacitance of the split ring resonator 800.

The meta-material structures that are incorporated into connectors according to embodiments of the present invention may be tuned to have a negative refractive index over a range of frequencies that are of interest. In particular, as part of the connector design process, a particular range of frequencies may be identified as being particularly problematic with respect to pair-to-pair crosstalk and/or alien crosstalk. The meta-material structures used in the connectors may, for example, be tuned to exhibit a negative refractive index over this range of frequencies. Methods for tuning meta-material structures vary based on the type of meta-material employed. Exemplary methods are discussed, for example, in K. Aydin et al., Investigation of Magnetic Resonances for Different Split-Ring Resonator Parameters and Designs, New Journal of Physics, Vol. 7 (2005) at 168. For example, with respect to split ring resonators, and referring to the split ring resonator 100 of FIG. 3 herein, these methods include selecting the radius (r) of the rings, the width of the gaps 115, 125 in the rings 110, 120 that form the split ring resonator 100, the width of the gap 132 between rings, the widths w₁, w₂ of the rings 110, 120, and whether or not additional capacitance is integrated into the rings 110, 120 (e.g., by adding surface mount capacitors to the rings).

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A communications connector, comprising:
a plurality of conductors that form a plurality of pairs of conductors, wherein each pair of conductor is configured to carry a differential signal; and
at least one meta-material structure positioned adjacent at least some of the conductors.

2. The communications connector of claim 1, wherein the communications connector comprises a communications jack, and wherein each conductor comprises a jackwire contact.

3. The communications connector of claim 1, wherein the communications connector comprises a communications plug, and wherein each conductor comprises a plug contact.

4. The communications connector of claim 1, wherein the meta-material structure comprises a split ring resonator.

5. The communications connector of claim 4, wherein the split ring resonator comprises a pair of concentric rings of conductive material on a substrate, wherein each ring of conductive material includes a gap.

6. The communications connector of claim 1, wherein the at least one meta-material structure comprises a first meta-material structure that is positioned above the plurality of conductors and a second meta-material structure that is positioned below the plurality of conductors.

7. The communications connector of claim 1, wherein the communications connector is positioned adjacent to a second communications connector, and wherein the meta-material structure is positioned between the conductors of the communications connector and a plurality of conductors of the second communications connector.

8. The communications connector of claim 1, wherein the meta-material structure is positioned between a first of the plurality of pairs of conductors and a second of the plurality of pairs of conductors.

9. The communications connector of claim 1, wherein the at least one meta-material structure comprises an array of split ring resonators.

10. The communications connector of claim 1, wherein the meta-material structure is configured to reduce alien crosstalk.

11. A communications connector, comprising:
a housing;
a plurality of contacts mounted at least partly within the housing;
a meta-material structure mounted to or within the housing and positioned so as to reduce an electromagnetic field emanated from at least one of the plurality of contacts.

12. The communications connector of claim 11, wherein the communications connector comprises a communications plug, wherein the contacts are arranged in a generally side-by-side relationship to form a row of contacts, and wherein the meta-material structure is positioned either above or below the row of contacts.

13. The communications connector of claim 11, wherein the communications connector comprises a communications jack, wherein the housing defines a generally rectangular plug receiving cavity having a top wall, a bottom wall and first and second side walls, wherein the bottom wall includes a recess therein that is configured to receive a latch of a mating plug, and wherein the meta-material structure is positioned adjacent to the top wall, the bottom wall, the first side wall or the second side wall of the plug receiving cavity.

14. The communications connector of claim 13, wherein the meta material structure is positioned adjacent the top wall of the plug receiving cavity, the connector further comprising a second meta-material structure positioned adjacent the left sidewall of the plug receiving cavity, a third meta-material structure positioned adjacent the right sidewall of the plug receiving cavity, and a fourth meta-material structure positioned adjacent the bottom wall of the plug receiving cavity.

15. The communications connector of claim 11, wherein the meta-material structure comprises a split ring resonator.

16. The communications connector of claim 15, wherein the split ring resonator comprises a pair of concentric rings of conductive material printed on a substrate, wherein each ring of conductive material includes a gap.

17. The communications connector of claim 11, wherein the meta-material structure comprises a first meta-material structure that is positioned above the plurality of contacts, the connector further comprising a second meta-material structure that is positioned below the plurality of contacts.

18. The communications connector of claim 11, wherein the communications connector is positioned adjacent to a second communications connector, and wherein the meta-material structure is positioned between the plurality of contacts of the communications connector and a plurality of conductors of the second communications connector.

19. The communications connector of claim 11, wherein the meta-material structure is positioned between a first of the plurality of pairs of contacts and a second of the plurality of pairs of contacts.

20. A method of reducing crosstalk in a communications connector that includes a plurality of differential pairs of conductors, the method comprising:
positioning at least one meta-material structure adjacent at least some of the plurality of differential pairs of conductors.
